(19) United States
(12) Patent Application Publication
(10) Pub. No.: US 2026/0216985 A1
(43) Pub. Date: Jul. 30, 2026

(54) Bonded Seam, Method, and Device for Joining Material Webs or Material Sheets with a Thermally Activatable Adhesive and Use of an Impact Press

(71) Applicant: Fraunhofer-Gesellschaft zur Förderung der angewandten Forschung Eingetragener Verein, München (DE)

(72) Inventor: Mathias Kott, Dresden (DE)

(21) Appl. No.: 19/148,338

(22) PCT Filed: Jan. 12, 2024
(86) PCT No.: PCT/DE2024/100022

§ 371 Date: Jul. 16, 2025

(30) Foreign Application Priority Data
Jan. 16, 2023 (DE) 10 2023 100 891.9

(51) Int. Cl. B31B 70/62

(52) U.S. Cl. CPC B31B 70/62

(57) ABSTRACT

The invention relates to a bonded seam, a method, and a device for joining material webs (10) by means of a thermally activatable adhesive, in particular a hot-melt adhesive (11), wherein the material webs (10) are joined between impact elements (2, 4) along a bonded seam (12). According to the invention, an impact pulse is applied to the material webs or material sheets (10), arranged one above the other between a pair of unheated impact elements (2, 4), between which the adhesive (11) is located. The bonded seam (12) is formed by this impact pulse, wherein the impact pulse penetrates at least partially into the adhesive (11) and thereby activates the adhesive, wherein the activation is restricted to the region of the extension of the bonded seam (12), and wherein a height of the bonded seam (12) results which is less than the height of both material webs or material sheets (10), and wherein all of the liquefied adhesive (11) participates in the formation of the bonded seam (12) and the region of the liquefied adhesive (11) remains limited to the bonded seam (12). The invention also relates to the use of an impact press.

### CROSS REFERENCE TO RELATED APPLICATIONS

This application is the U.S. national stage of International Application No. PCT/DE2024/100022, filed on 2024 Jan. 12. The international application claims the priority of DE 102023100891.9 filed on 2023 Jan. 16; all applications are incorporated by reference herein in their entirety.

### BACKGROUND

The invention relates to a bonded seam for joining material webs or material sheets by means of a thermally activatable adhesive, in particular a hot-melt adhesive. The material webs or material sheets consist in particular of non-sealable materials such as paper, metal or textile, wherein formed material webs or material sheets or sections thereof are also encompassed by the invention, for example, sections of material webs or material sheets that have already been formed into packaging. The invention also relates to a method and device for joining material webs or material sheets by means of a thermally activatable adhesive, wherein the material webs or material sheets are joined along a bonded seam, and also to the use of an impact press.

An important area of application for integral joining by means of a thermally activatable adhesive is the production and sealing of packaging, wherein a hot-melt adhesive (also referred to as melt adhesive, hot-melt, hot glue, or hot-melt adhesive) enables quick sealing, for example in boxes, e.g., as outer packaging or collective packaging. The adhesive melts upon heating, whereby it is activated for integral joining. After application to the bonding area, the adhesive cools and hardens within a short time. As soon as the adhesive has cured, the bonded joint can be immediately loaded. A disadvantage is that sprayed hot-melt adhesive is very difficult to remove during cleaning of the equipment. In addition, hot-melt adhesive can only be used on relatively large, stable objects, since sufficient contact pressure is required after application to obtain a strong bonded joint. Directly applied hot-melt adhesives are not suitable in particular for flexible materials and very small bonding areas.

In order to avoid the disadvantages associated with applying the hot-melt adhesive at the time of bonding, the hot-melt adhesive may already be applied beforehand over the entire surface or exclusively in the subsequent bonding area. Such solutions are known in various embodiments, with the publication DE 10 2019 112 788 A1 being cited as an example. There, a device and a method for coating material webs or material sheets, in particular a paper web or a paper sheet, with hot-melt adhesive are described. In this case, the hot-melt adhesive is applied in stripes only where bonding is to take place later. The material webs or material sheets prepared in this way are then suitable for processing and bonding in a known heat-sealing process. For this purpose, in a sealing zone in which the required heat is introduced into the material, the coated material web is bonded to another layer of the material.

Heat sealing refers to thermal joining by means of heated welding elements, also known as sealing elements. A method and a device for heat sealing are described in publications DE 10 2011 080 462 A1 and DE 10 2016 218 190 A1. Many efforts are being made to dispense with heated welding elements. There are two main reasons for this: the safe packaging of heat-sensitive goods while avoiding the input of heat energy and the reduction of energy consumption.

By means of thermal joining using ultrasound, heated impact elements can be dispensed with, because the thermal effect in the films to be joined is generated by the energy input of the ultrasonic vibrations themselves. This effect is the basis for the ultrasonic sealing solutions which are described in publications DE 699 26 758 T2, DE 10 2009 046 319 A1, and DE 10 2017 121 572 A1, in combination with heat sealing. However, the mechanical equipment required for ultrasonic sealing and ultrasound generation are very complex.

The heat input can also be avoided by using a cold-sealable polymer dispersion, as proposed in publication WO 2011/003864 A1. However, it is necessary to apply a special polymer dispersion at the joint.

Other methods for processing material webs or material sheets, such as separating them by means of an impact pulse using a foil punch according to publication DE 10 2015 211 622 A1, are also not suitable for joining hot-melt adhesive-coated material webs or material sheets together and forming a bonded or sealed seam.

### SUMMARY

The invention relates to a bonded seam, a method, and a device for joining material webs (10) by means of a thermally activatable adhesive, in particular a hot-melt adhesive (11), wherein the material webs (10) are joined between impact elements (2, 4) along a bonded seam (12). According to the invention, an impact pulse is applied to the material webs or material sheets (10), arranged one above the other between a pair of unheated impact elements (2, 4), between which the adhesive (11) is located. The bonded seam (12) is formed by this impact pulse, wherein the impact pulse penetrates at least partially into the adhesive (11) and thereby activates the adhesive, wherein the activation is restricted to the region of the extension of the bonded seam (12), and wherein a height of the bonded seam (12) results which is less than the height of both material webs or material sheets (10), and wherein all of the liquefied adhesive (11) participates in the formation of the bonded seam (12) and the region of the liquefied adhesive (11) remains limited to the bonded seam (12). The invention also relates to the use of an impact press.

### DETAILED DESCRIPTION

It is therefore the object of the present invention to provide a bonded seam for joining material webs or material sheets, e.g., made of paper, but also of metal or textile, by means of a thermally activatable adhesive and, in addition, a robust, uncomplicated method for joining material webs or material sheets by means of a thermally activatable adhesive along a bonded seam. Further objects of the invention are to provide an energy-saving and simple device for joining material webs or material sheets by means of a thermally activatable adhesive along a bonded seam and the use of an impact press.

The problem is solved by a bonded seam for joining material webs or material sheets, e.g., made of paper, paper materials, but also of metal or textile, formed by means of a thermally activatable adhesive, which materially joins the material webs or material sheets. According to the invention, an impact pulse is applied to the material webs or material sheets, which are arranged one above the other between a pair of unheated impact elements, between which the adhesive is located. This represents a stroke movement of at least one of the impact elements perpendicular to the material webs or material sheets, with a penetration duration of at least one of the impact elements into the material webs or material sheets of less than 10 ms, whereby the bonded seam is formed. The bonded seam is formed by the impact pulse penetrating the adhesive and deforming it. During deformation, heat develops in the adhesive, whereby it is thermally activated, wherein the thermal activation is limited to the area of the bonded seam, in particular its horizontal extent.

The application of the impact pulse furthermore results in a height of the bonded seam that is less than the height of both the material webs or material sheets which are arranged one above the other and joined together by the bonded seam. The impact pulse also causes deformation of the material webs or material sheets.

During the formation of the bonded seam, all of the liquefied adhesive participates in the formation of the bonded seam, and the area of the liquefied adhesive remains restricted to the bonded seam. Thus, in contrast to heat sealing, the adhesive does not escape from the area of the bonded seam, so that no disadvantageous deformations occur along the bonded seam as a result. The result is a higher-quality bonded seam, and the adhesive can be used more efficiently because it can be applied more thinly and therefore in smaller quantities. The avoidance of expelled adhesive, or the restriction of the liquefied adhesive to the bonded seam, as well as the compression of the seam, are characteristic of the bonded seam produced by an impact pulse according to the invention.

It has proven advantageous if the impact pulse penetrates at least 50% into the adhesive, i.e., at least 50% of the adhesive must be deformed.

The effect of the impact pulse takes place between the unheated impact elements. In any case, it is not necessary to heat the impact elements; indeed, it is even disadvantageous, especially if such heating, as an external supply of heat, leads to premature softening of the adhesive. Thus, preheating of the material webs or material sheets is also precluded. Therefore, ‘unheated’ is to be understood as a temperature of the impact elements and the material webs or material sheets that is below the softening temperature of the adhesive. If, for other reasons, there is a slight heating of the impact elements or the material webs/sheets, this does not affect the method according to the invention, and the impact elements and the material webs/sheets are regarded as unheated or not preheated within the meaning of the invention. A pair of (unheated) impact elements also exists if they are an unequal pair and one impact element works against a flat, non-profiled anvil, which then forms the second impact element of the pair within the meaning of the invention.

The impact pulse is a stroke movement of at least one of the impact elements essentially perpendicular to the material webs or material sheets, with a penetration duration of at least one of the impact elements into the material webs or material sheets, with the adhesive therebetween, of less than 10 ms. Preferably, the penetration duration is less than 5 ms, particularly preferably less than 1 ms, and depending on the film thickness, from 0.05 to 0.5 ms. For this purpose, the tool, preferably at a starting speed of 1 to 5 m/s for the impact pulse, plunges onto the assembly of material webs or material sheets with the adhesive, and is decelerated to a standstill during the penetration duration while releasing and converting the kinetic energy. With the conversion of the kinetic energy of the impact pulse, the adhesive in particular is deformed and is thereby heated. The impact pulse is preferably generated by a mechanical drive, alternatively by an electric magnetic drive.

According to a first alternative, the thermally activatable adhesive is applied to at least one of the material webs or material sheets, at least in the area of the bonded seam or also over the entire surface. Full-surface application is associated with greater flexibility in the position of the bonded seam, but also with higher material usage for the adhesive and with more complicated recycling.

According to a second alternative, the thermally activatable adhesive is arranged between the material webs or material sheets at least in the area of the bonded seam to be produced before the impact pulse is applied, without being bonded to one of the material webs or material sheets. In a web-guiding process, for example, a strip of adhesive from a roll can be supplied between the material webs or material sheets.

An advantageous embodiment or application consists in that the material web or the material sheet is joined in the area of the previously opposing edges folded over one another by the bonded seam, which forms a longitudinal seam. In this way, a tube is formed. The material webs or material sheets arranged one above the other may therefore also be a single folded-over material web or material sheet.

According to a further embodiment, this tube becomes a tubular bag by means of at least one additional bonded seam, which forms a transverse seam and seals the previously formed tube at at least one end with a bottom seam. For closing the tubular bag, the opening is also provided with a transverse seam, i.e., a top seam. A multilayer tubular bag can also be produced in this way by feeding in more layers when the tube is formed.

It has been shown that the impact pulse creates an embossing in the material webs or material sheets in the area of the bonded seam, which is formed by the striking of the impact elements against the material webs or material sheets in accordance with the contour of the impact elements. This effect can be used for further applications, such as for strengthening the material, for embossing information, or for aesthetic design.

Preferably, the thermally activatable adhesive is a hot-melt adhesive, as is frequently used, and not least, in the packaging industry. Against this background, the advantageous application of the invention is with material webs or material sheets consisting of paper or a paper material. These materials are also widely used in the packaging industry, and are furthermore dependent on adhesive bonds when an integral joining is required.

The object of the invention is further achieved by a method for joining material webs or material sheets by means of a thermally activatable adhesive, wherein the material webs or material sheets are joined along a bonded seam. According to the invention, an impact pulse acts on the material webs or material sheets arranged one above the other between a pair of unheated impact elements, with a stroke movement of at least one of the impact elements extending perpendicular to the material webs or material sheets. It is not necessary to heat the impact elements; rather, it is disadvantageous, especially if such heating, as an external supply of heat, leads to softening of the material web or material sheet. Thus, preheating of the material web or material sheet is also precluded. Therefore, ‘unheated’ is to be understood as a temperature of the impact elements and the material web or material sheet that remains below the softening temperature of the material web or material sheet. If, for other reasons, the impact elements or the material web/sheet are slightly heated, this has no effect on the method according to the invention and the impact elements or the material web/sheet are considered to be unheated or not preheated within the meaning of the invention.

Due to the rapid rise in temperature, the material temperature has little influence, as long as no detrimental softening of the material occurs due to excessive temperature. The same applies to the impact elements, which do not need to be preheated, since the temperature required for bonding is generated in a very short time during the pulse in the material webs or material sheets or in the adhesive itself. The heating and melting of the adhesive is therefore advantageously limited to an immediate effective zone and a short contact time. Due to the high deformation speed, adiabatic heating of the adhesive and/or the material web or material sheet in the effective zone occurs with minimal energy input, without heat exchange with the surrounding air and the adjacent regions of the material web or material sheet and the adhesive. Only as much adhesive is liquefied as is required for the joining. This simultaneously prevents liquid adhesive from being expelled from the joining area or the effective zone and not participating in the joint to form the bonded seam.

The bonded seam is preferably produced to be very narrow, which leads, not least, to material savings. In addition, there is a saving of time and reduced energy input. Such a narrow bonded seam or such a narrow heat-affected zone cannot be achieved with conventional heat-sealing processes for activating the adhesive, because the heat would be dissipated too quickly, and as a result the heated and softened area in the material web or material sheet would be enlarged.

The impact pulse acts with a penetration duration of at least one of the impact elements into the material webs or material sheets and the adhesive located between them of less than 10 ms. It is advantageous if at least 50% of the adhesive is deformed during the impact pulse. This activates the adhesive and forms the bonded seam. This is followed by the immediate return stroke of at least one impact element, in order to release the material web or material sheet with the formed bonded seam.

In a step preceding the impact pulse, the material webs or material sheets and the adhesive are pressed against each other between the pair of impact elements with a pre-tensioning force Fᵥ. Thereafter, the impact pulse of at least one of the driven impact elements (or transmitted by at least one of the impact elements) acts on the material webs or material sheets and the adhesive. Thus, as an alternative to the tool falling directly onto the material web or material sheet, the roughness of the tool surfaces, and especially of the material webs or material sheets arranged one above the other, is initially partially compensated by the adhesive. In all cases, a temperature effect arises in the effective zone, i.e., the developing bonded seam, which leads to localized, very brief melting of the adhesive during the penetration duration and the mechanical loading occurring during penetration, at a correspondingly high deformation speed.

In the transmission of the impact pulse, in particular by the impact elements, a speed of sound and an impact pulse time of less than 10 ms, preferably 5 ms, are assumed. For the steel/steel pulse, a time of 0.25 ms was calculated for a distance of 10 cm. With the impact pulse, an effect comparable to ultrasonic sealing is achieved on comparable materials; however, instead of a large number of pulses of low amplitude as in ultrasonic sealing, only a single pulse, namely the impact pulse according to the invention, is applied. In both processes, when using ultrasound and an impact pulse, the temperature increase required for thermal joining is achieved by a physical-chemical effect in the adhesive. At the same time, further advantages are realized, in particular the absence of heat input and thus the thermal protection of a packaged product, which is also decisive for the use of ultrasonic sealing, but without the need for complex equipment technology with ultrasonic generation and a sonotrode.

The melting of the adhesive remains limited to the effective zone. As a result, neither is the environment affected by undesirable heat input (e.g., the area surrounding the bonded seam in the material web or material sheet, or a packaged product), nor is heat dissipated to the environment as energy loss.

The impact pulse is preferably generated by a mechanical or magnetic drive, wherein the impact elements being driven directly, or the impact pulse being transmitted indirectly by means of spring force, a drop weight, a magnetic drive, or a cam gear. With the cam gear, particularly fast movements can be controlled without delay and with precise amplitude. In particular, the spring force and the drop weight can be manually brought into the position where they generate force, so that the method according to the invention can be carried out without an external energy supply.

The impact pulse is applied by the upper impact element or, alternatively, by both opposing impact elements. Particularly with opposing impact elements, these can also be used for a high-speed process, for example in a tubular bag machine with, e.g., 100 cycles per minute, and can be integrated therein. In this context, the impact elements can be configured as rollers, which can simultaneously function as feed rollers. The feed rollers apply the pre-tensioning force Fᵥ, while the pulse force Fᵢ is transferred to the material web or material sheet and the adhesive arranged between them by an impact applied to the rollers.

According to a first alternative, the thermally activatable adhesive is applied to at least one of the material webs or material sheets, at least in the area of the bonded seam, wherein it is then bonded to the material web or material sheet. According to a second alternative, the thermally activatable adhesive is arranged between the material webs or material sheets, at least in the area of the bonded seam to be produced, prior to application of the impact pulse, wherein it is not bonded to either of the two material webs or material sheets.

Furthermore, it has proven advantageous if the material web or material sheet is joined in the area of the edges by the bonded seam, wherein the bonded seam forms a longitudinal seam to produce a tube. In addition, the tube can be closed by bonded seams forming cross seams, thereby producing a tubular bag.

According to an advantageous embodiment, a strip of the thermally activatable adhesive is supplied together with the material web or material sheet during the forming of the tube and is introduced or arranged between the overlapping edges of the material web or material sheet.

It has been shown that when the impact elements strike the material webs or material sheets, an embossing is produced in the material webs or material sheets corresponding to the contour of the impact elements. It has also proven advantageous when the opposing impact elements are used in a continuous, high-speed process, as described in more detail above.

Preferably, the thermally activatable adhesive is a hot-melt adhesive. Preferably, the material webs or material sheets are made of paper or a paper material that requires an adhesive for a material bond and, unlike a plastic film, cannot be welded.

A further advantageous alternative is a bonded seam that is designed as an adhesive point, and wherein the material webs or material sheets are joined by a plurality of such adhesive points arranged in a row. In this way, any seam shape, each consisting of a plurality of adhesive points, can be produced, without the need for impact elements shaped accordingly. Moreover, only a low pulse energy is required for the small area of the adhesive points, such that the system can be compact and implemented without complex drives. In order to achieve broad flexibility, such a method is suitable for material webs/material sheets that are completely coated with adhesive.

The object of the invention is further achieved by a device for joining material webs or material sheets by means of a thermally activatable adhesive along a bonded seam. According to the invention, the device comprises a pair of unheated impact elements. A pair of unheated impact elements also exists if one impact element acts against an abutment, a flat anvil, which then constitutes the second impact element of the pair. The pair of unheated impact elements is provided to receive the material webs or material sheets arranged one above the other, with adhesive arranged between them. Furthermore, a device for pulse generation is included, which is configured to introduce an impact pulse into at least one of the impact elements in order to activate the adhesive. The impact pulse is a stroke movement of at least one of the impact elements perpendicular to the material webs or material sheets, wherein the penetration time into the material webs or material sheets and the adhesive is less than 10 ms. The impact pulse acts on the material webs or material sheets and, by activating the adhesive, forms the bonded seam in the effective area of the impact elements. The impact pulse is preferably generated by a drive device.

According to an advantageous further development, a device for applying a pre-tensioning force (Fᵥ) is provided, by means of which the impact elements are pressed against one another by the pre-tensioning force (Fᵥ) prior to application of the impact pulse.

In the preferred embodiment, the pair of impact elements comprises at least a first impact element with an effective area having a profiled cross-section. It has also proven advantageous if the pair of impact elements comprises the second impact element with a flat effective area. An advantageous profiled cross-section has a flat profile bounded by two radii R2, with any contour shape, and a width a that covers at least the area of the bonded seam. In a preferred embodiment, the profiled cross-section at the effective location, which is in contact with the material webs or material sheets to be bonded during the bonding process or the impact pulse, is formed as a flat profile bounded on both sides by two radii R2, preferably with R2=1 to 4 mm, and having a width a, at least a=2 mm.

According to an advantageous embodiment, the first and/or second impact element is designed as a rolling tool for use in a web-guiding process with continuous feed, as also described in more detail above as a high-speed process. Alternatively, the first and/or second impact element can be configured as a tool that swivels toward the effective point, or as a tool that is temporarily moved along with the web during the bonding process, as is customary and generally known for certain processing stages in web-guiding processes. The device according to the invention is therefore suitable for installation in packaging systems, wherein established sealing technology can also be replaced. It is advantageous if the pair of impact elements is made of hardened steel with a ground surface. In addition, each impact element contains elements for attachment to the drive device.

According to a first embodiment, the drive device acts on the first impact element, or according to a second embodiment, on the first and second impact elements. The drive device for generating the impact pulse preferably has a spring, a drop weight, or a mechanical gear. According to an advantageous embodiment, the mechanical gear is a cam gear, the advantages of which have already been explained above. A magnetic drive is also provided, which directly drives the impact element or the associated punch.

A further aspect of the present invention relates to the use of an impact press as a drive device for a device for joining material webs or material sheets by means of a thermally activatable adhesive, as described above.

Pneumatic impact presses are suitable not only for embossing metals, but also for marking plastics and similar products. Small impact presses are also frequently used in the pharmaceutical industry to emboss medicine boxes. With a spring, the desired impact force can be precisely set and adjusted, and consistent embossing results can be achieved in every embossing process in the same material. The pre-tensioning effect, which also plays a decisive role in the method according to the invention, allows for precise positioning of the workpiece and prevents deformation. By means of a clamping system, different embossing tools such as machine stamps, machine type holders, and embossing units can be clamped into these machines. An example embossing press possesses an impact force of 6 kN.

Compared to established sealing methods such as heat contact sealing or ultrasonic sealing, the method proposed according to the invention offers the following advantages:
cold tools, adiabatic joining process;
use with heat-sensitive products;
very cost-effective and robust system and tool technology;
purely mechanical and manually operated solutions can be implemented (spring pre-tensioning);
extremely short process time;
smallest seam widths can be achieved;
specific seam and embossing patterns can be obtained by using profile patterns on the tool;
conventional packaging forms (side-sealed bags, tubular bags) can be implemented;
very low energy requirements, and therefore very high energy efficiency.

For comparison, in heat-pulse joining of a material web or material sheet having a thickness of 20 to 100 μm and a typical seam length, an electrically generated heat pulse of 0.8 seconds at 165° C. is required. This corresponds to an energy consumption of 200 J when using a sealing pliers. In contrast, joining using the method according to the invention requires only 5 J of energy for the same seam length. This corresponds to an energy saving of 97.5%.

The above advantages result in advantageous areas of application in the following:
packaging processes using material webs or material sheets (for technical products, food, medical products) for both high-speed series applications and individual processes in decentralized production;
use in continuous processes due to high process speed;
use with recyclable and compostable films;
applications for sealing without electrical energy using spring pre-tensioning for mobile use, medical technology for development aid (packaging medical samples on site), disaster relief (sealing sandbags);
packaging in dust-laden environments.

### BRIEF DESCRIPTION OF THE DRAWINGS

The invention is explained in more detail below on the basis of the description of embodiments and their illustration in the associated drawings. The drawings show:

FIG. 1: schematic view of a process sequence of the method according to the invention for joining material webs or material sheets by thermal joining;

FIG. 2: schematic perspective view of an embodiment of an impact element according to the invention, with an effective area having a flat profiled cross-section bounded by two radii;

FIG. 3: schematic perspective view of an embodiment of a first impact element according to the invention with an effective area with a flat profiled cross-section;

FIG. 4: schematic perspective view of an embodiment of a second impact element according to the invention with a flat effective area;

FIG. 5: two schematic views of an embodiment of an impact press;

FIG. 6: schematic side view of an embodiment of a continuous web-guiding process;

FIG. 7: two schematic views of a further embodiment of a continuous web-guiding process;

FIG. 8: schematic perspective view of an embodiment of a bonded seam according to the invention on a tube;

FIG. 9: schematic perspective view of an embodiment of bonded seams according to the invention on a tubular bag;

FIG. 10: schematic side view of an embodiment of a device according to the invention with a joined material web or material sheet;

FIG. 11: schematic enlarged view of a joining location with joined material webs or material sheets.

### DETAILED DESCRIPTION OF THE PREFERRED EMBODIMENTS

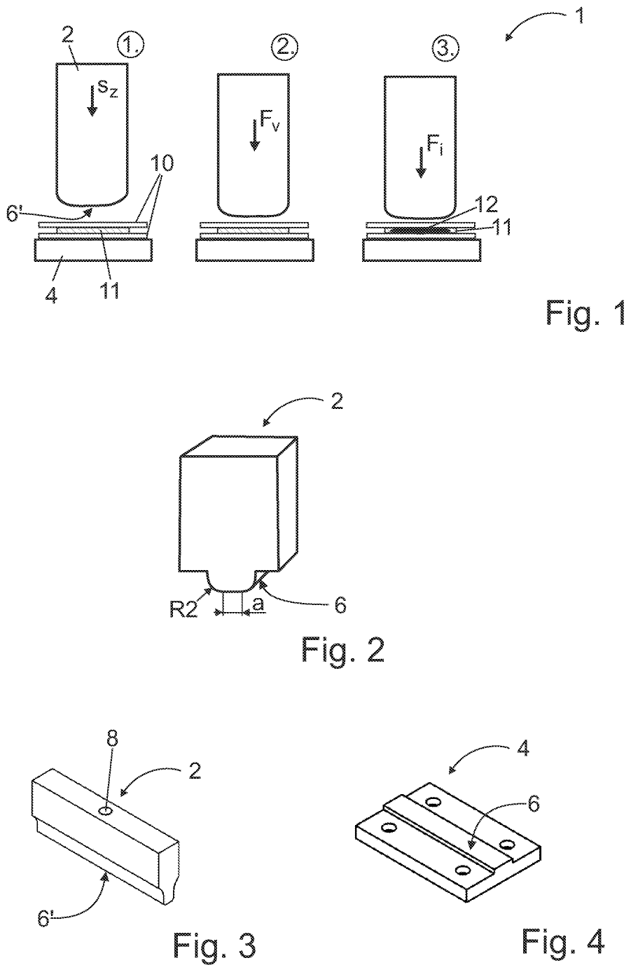

FIG. 1 shows, schematically, a view of an embodiment of a process sequence of the method according to the invention for joining material webs/material sheets 10 by means of a thermally activatable adhesive 11 using an impact pulse. The process sequence is shown in three steps, starting from the left. First, the first impact element 2 is moved along the infeed path s_{z} to the surface of the material webs/material sheets 10, between which the adhesive to be activated, namely a hot-melt adhesive 11, is arranged, in the direction of the arrow, until an effective profile 6 contacts the material web/material sheet 10. The two material webs/material sheets 10 to be joined by a bonded seam 12 rest on the surface of the second impact element 4, which in this case is configured as a flat anvil. The effective profile 6 is also flat and tapers into radii in order not to damage the material web/material sheet 10.

In a second step, the first impact element 2 is pressed, with a pre-tensioning force Fᵥ, against the material webs or material sheets 10, with the hot-melt adhesive 11 positioned therebetween. Under the preload thus created, which compensates for surface roughness and the elasticity of the material structure, the pulse force Fᵢ is applied in the third step, resulting in activation of the hot-melt adhesive 11, which melts briefly in the effective zone, thereby forming the bonded seam 12.

FIG. 2 schematically shows a perspective view of an embodiment of impact element 2 according to the invention, having a flat profiled cross-section that tapers into two radii R2 and forms an effective profile 6, as used in FIG. 1. In an exemplary effective profile 6, the preferred radius R2 is 1 to 4 mm, and the flat profile has a width of at least a=2 mm.

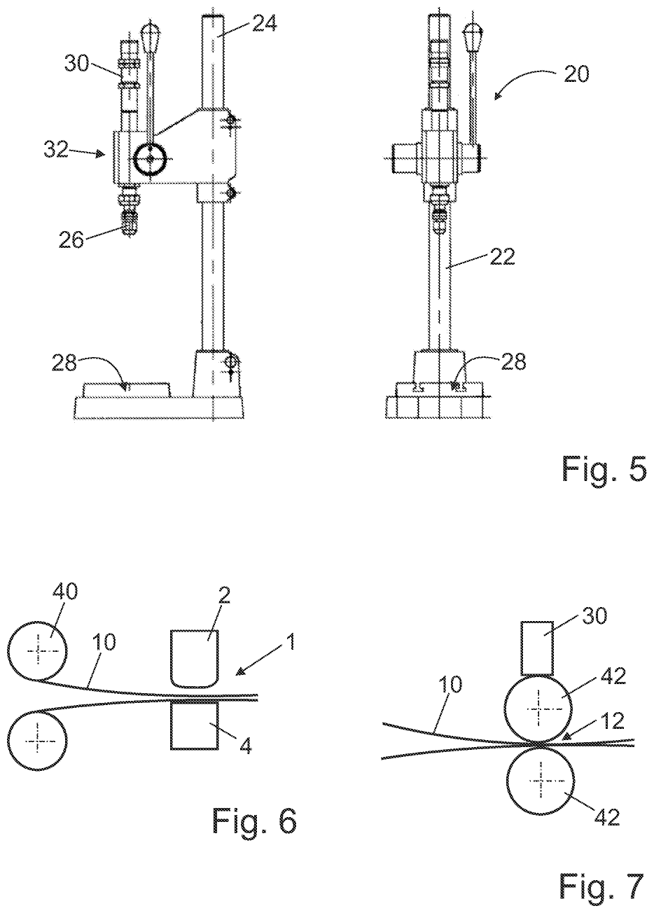

FIG. 3 schematically shows a perspective view of an embodiment of a first impact element 2 according to the invention with an effective area 6 with a flat profiled cross-section, as shown in detail in FIG. 2. A mounting opening 8 serves to receive a clamping bolt (not shown here), by means of which the first impact element 2 is fastened in an impact element holder 26 (see FIG. 5) of a machine that applies the pre-tensioning force Fᵥ and the pulse force Fᵢ to the first impact element 2.

FIG. 4 schematically shows a perspective view of an embodiment of a second impact element 4 according to the invention with a flat, anvil-like effective area 6. The second impact element 4 is fastened to an impact element holder 28 (see FIG. 5).

FIG. 5 schematically shows, in two views, an embodiment of an impact press 20, with which the method according to the invention can be performed. It is particularly advantageous that such an impact press 20 can be operated without electrical power and purely manually, in particular as a spring impact press according to the illustrated embodiment. The force required for the feed movement along the infeed path s_{z}, as well as for the pre-tensioning force Fᵥ and the pulse force Fᵢ, is applied by the operator via an operating lever 24.

As shown in FIG. 1, the bonded seam 12 is produced between the second impact element 4, on which the material webs/material sheets 10 rest, and the first impact element 2, which is fastened in a first impact element holder 26. For this purpose, the operating lever 24 is actuated, and the first impact element holder 26 is moved toward the second impact element holder 28 via a feed device 32, until the first impact element 2, inserted in the first impact element holder 26, contacts the material web or material sheet 10.

By further movement of the operating lever 24, the required pre-tensioning force Fᵥ is applied; and by further movement of the operating lever 24, during which a spring is tensioned, the pulse force Fᵢ is applied to the material web or material sheet 10 by triggering the pulse generator 30. Thus, the bonded seam 12 is produced in the area of the contact zone between the first impact element 2 and the second impact element 4. The return stroke of the second impact element holder 26, by counter-movement of the operating lever 24, releases the sealed, bonded material webs or material sheets 10.

FIG. 6 schematically shows, in side view, an embodiment of a continuous web-guiding process in which the material web or material sheet 10 unwinds from a web roll 40. In device 1 for joining material webs/material sheets 10 by bonding, the material webs/material sheets 10 pass between the first impact element 2 and the second impact element 4, where the bonded seam 12 is produced (in the illustration, the bonded seam 12 has not yet been formed). However, precautions must be taken to ensure the continuity of the web-guiding process, even during the application of the pre-tensioning force, in particular, and the impact pulse. This can be accomplished, for example, by cyclically advancing and retracting device 1 in or against the web-guiding direction, or by providing a web accumulator in front of device 1 (both not shown, but known from the prior art).

FIG. 7 shows a schematic side view of another embodiment of the continuous web-guiding process. The pre-tensioning force is applied by pre-tensioning rollers 42, between which the material web/material sheets 10 pass. A device for pulse generation 30, in particular an impact mechanism, acts on one or both pre-tensioning rollers 42, so that the bonded seam 12 is produced.

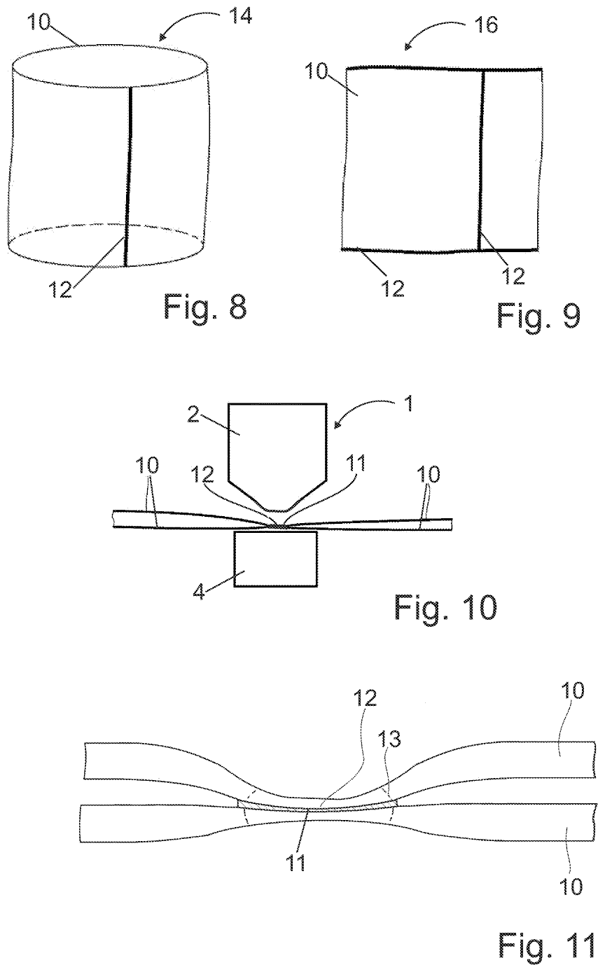

FIG. 8 schematically shows a perspective view of an embodiment of a bonded seam 12 according to the invention on a tube 14, which is formed from a folded and joined section of a material web 10. The tube 14 can advantageously be used as sleeve packaging, in which it is pushed over an otherwise finished package.

FIG. 9 schematically shows a perspective view of an embodiment of additional bonded seams 12 according to the invention, here on a tubular bag 16. This includes a tube 14, as shown in FIG. 8, which is closed at both ends with transverse seams. This is usually carried out on the second, typically upper, side after filling with a packaged product. The bottom seam, i.e., the lower bonded seam 12, of the next tubular bag 16 can be produced simultaneously.

FIG. 10 schematically shows a side view of an embodiment of device 1 according to the invention during bonding of the material webs/material sheets 10 by forming a bonded seam 12. This is particularly evident in the enlarged view in FIG. 11. Device 1 comprises the impact elements 2, 4, shown after the return stroke, which releases the bonded seam 12.

FIG. 11 schematically shows an enlarged view of a bonded joint, specifically the bonded seam 12 with connected material webs/material sheets 10, wherein the material webs/material sheets 10 extend on both sides of the bonded seam 12. The very low bonded seam 12 in the effective zone, and the hot-melt adhesive 11 fused with the material webs/material sheets 10, are visible. The compression is also partly due to the fact that the material webs/material sheets 10 consist of compressible or heat-sensitive material, the height of which was also reduced by the impact pulse.

The hot-melt adhesive 11, which protrudes undeformed next to the bonded seam 12, does not appear thickened, as occurs in other heat-sealing processes according to the prior art, where liquid adhesive is squeezed out. This clearly demonstrates that no excess adhesive 11 is melted and displaced. Rather, the heat—affected area 13—whose boundary to the unaffected material webs/material sheets 10 (and to the hot-melt adhesive 11, insofar as it protrudes beyond the activation zone in the area of the bonded seam) is indicated by a dashed line—is limited to the area of the bonded seam 12, and neither the material webs/material sheets 10 nor any area outside the material webs/material sheets 10, for example a packaged product inside a package, is affected by undesired heating.

### LIST OF REFERENCE NUMERALS

1 Device
2 First impact element
4 Second impact element
6 Effective range and effective profile
8 Mounting opening
10 Material webs/material sheets
11 adhesive, thermally activatable adhesive, hot-melt adhesive
12 Bonded seam, longitudinal seam, transverse seam
13 Heat-affected area
14 Tube
16 Tubular bag
20 Impact press
22 Stand
24 Operating lever
26 First impact element holder
28 Second impact element holder
30 (Device for) pulse generation
32 Feed device
40 Web roller
42 Rolling tool, pre-tensioning roller
a Effective profile width
R1 First effective profile radius
R2 Second effective profile radius
R3 Third effective-profile radius
Fᵥ Pre-tensioning force
Fᵢ Pulse force and intensity of impact pulse
s_{z} Infeed path

1. A bonded seam for joining material webs or material sheets (10) by means of a thermally activatable adhesive (11), characterized in that an impact pulse, in the form of a stroke movement of at least one of a pair of unheated impact elements (2, 4), acts perpendicularly on the material webs or material sheets (10) arranged one above the other, between which the adhesive (11) is located, wherein the penetration time of at least one of the impact elements (2, 4) into the material webs or material sheets (10) is less than 10 ms, wherein the bonded seam (12) is formed by the impact pulse penetrating at least partially into the adhesive (11) and thermally activating the adhesive (11), wherein the thermal activation is limited to the area of the bonded seam (12), wherein the resulting height of the bonded seam (12) is less than the height of both material webs or material sheets (10), and wherein all liquefied adhesive (11) participates in the formation of the bonded seam (12), and the area of the liquefied adhesive (11) remains limited to the bonded seam (12).

2. The bonded seam according to claim 1, wherein the thermally activatable adhesive (11) is applied to at least one of the material webs or material sheets (10) at least in the area of the bonded seam (12).

3. The bonded seam according to claim 1, wherein the thermally activatable adhesive (11) is arranged between the material webs or material sheets (10), at least in the area of the bonded seam (12) to be produced, without connection to the material webs or material sheets (10) prior to the application of the impact pulse.

4. The bonded seam according to claim 1, wherein the material web or the material sheet (10) is joined in the area of the edges by the bonded seam (12), which forms a longitudinal seam, thereby forming a tube (14).

5. The bonded seam according to claim 1, wherein the tube (14) is closed by bonded seams (12), which form transverse seams, to produce a tubular bag (16).

6. The bonded seam according to claim 1, wherein the thermally activatable adhesive (11) is a hot-melt adhesive.

7. The bonded seam according to claim 1, wherein the material webs or material sheets (10) consist of paper or a paper material.

8. A method for joining material webs or material sheets (10) by means of a thermally activatable adhesive (11), the material webs or material sheets (10) being joined along a bonded seam (12), characterized in that an impact pulse, as a stroke movement of at least one of a pair of unheated impact elements (2, 4) arranged one above the other, acts perpendicularly on the material webs or material sheets (10), with a penetration time of at least one of the impact elements (2, 4) into the material webs or material sheets (10) and the adhesive (11) being less than 10 ms, by which the adhesive (11) is activated and the bonded seam (12) is formed, followed by the return stroke of at least one of the impact elements (2, 4).

9. The method according to claim 8, wherein, in a step preceding the impact pulse, the material webs or material sheets (10) and the adhesive (11) are pressed against each other between the pair of impact elements (2, 4) with a pre-tensioning force Fᵥ, and thereafter, the impact pulse of at least one of the driven impact elements (2, 4), or transmitted by at least one of the impact elements (2, 4), acts on the material webs or material sheets (10) and the adhesive (11).

10. The method according to claim 8, wherein the mechanical drive of the impact elements (2, 4) is effected directly, or the impact pulse is transmitted indirectly by spring force, a drop weight, a magnetic drive, or a cam gear.

11. The method according to claim 8, wherein the impact pulse is applied by the upper impact element (2) or by both impact elements (2, 4) acting in opposition.

12. The method according to claim 8, wherein the thermally activatable adhesive (11) is arranged between the material webs or material sheets (10) at least in the area of the bonded seam (12) to be produced, prior to the application of the impact pulse.

13. The method according to claim 8, wherein the thermally activatable adhesive (11) is applied to at least one of the material webs or material sheets (10) at least in the area of the bonded seam (12).

14. The method according to claim 8, wherein the material web or the material sheet (10) is joined in the area of the edges by the bonded seam (12), which forms a longitudinal seam, thereby forming a tube (14).

15. The method according to claim 14, wherein a strip of adhesive (11) is supplied together with the material web or material sheet during the forming of the tube (14) from the material web or material sheet and is arranged between the overlapping edges of the material web or material sheet.

16. The method according to claim 8, wherein the tube (14) is closed by adhesive seams (12) forming transverse seams, thereby producing a tubular bag (16).

17. The method according to claim 16, wherein the opposing impact elements (2, 4) are used in a continuous, high-speed process.

18. The method according to claim 8, wherein the thermally activatable adhesive (11) is a hot-melt adhesive.

19. The method according to claim 8, wherein the material webs or material sheets consist of paper or a paper material.

20. A device for joining material webs or material sheets (10) by means of a thermally activatable adhesive (11) along a bonded seam (12),
characterized in that the device (1) comprises a pair of unheated impact elements (2, 4) configured to receive the material webs or material sheets (10), arranged one above the other, with the adhesive (11) therebetween, wherein a device for pulse generation (30) is provided to introduce the impact pulse into at least one of the impact elements (2, 4) to activate the adhesive (11), wherein the impact pulse represents a stroke movement of at least one of the impact elements (2, 4) extending perpendicularly to the film layer, with a penetration time of at least one of the impact elements (2, 4) into the material webs or material sheets (10) and the adhesive (11) of less than 10 ms, wherein the impact pulse acts on the material webs or material sheets (10) and forms the bonded seam (12) in an effective area of the impact elements (2, 4) by activating the adhesive (11).

21. The device according to claim 20, wherein a device for applying a pre-tensioning force (Fᵥ) presses the impact elements (2, 4) against each other by means of the pre-tensioning force (Fᵥ) before the impact pulse is applied.

22. The device according to claim 20- or 21, wherein a profiled cross-section (6) is formed as a flat profile bounded by two radii R2, with a width a that covers at least the area of the bonded seam (12).

23. The device according to claim 20, wherein the first and/or second impact element (2, 4) is designed for use in a web-guiding process with continuous feed.

24. The device according to claim 23, wherein the first and/or second impact element (2, 4) is designed as a rolling tool (42), as a tool pivoting toward the effective area, or as a tool carried along with the web during the bonding process.

25. The device according to claim 20, wherein the pulse-generating device (30) comprises a spring, a drop weight, or a mechanical gear;

26. (canceled)
